(19) United States
(12) Patent Application Publication
(10) Pub. No.: US 2014/0274234 A1
(43) Pub. Date: Sep. 18, 2014

(54) Roto-Molded Plastic Grain Bin

(71) Applicant: AGCO CORPORATION, Duluth, GA (US)

(72) Inventors: Steven R. Tippery, Newton, KS (US); Bryan S. Claerhout, Hesston, KS (US); Eric M. Biggs, Hesston, KS (US); Eric Richard Michels, Jackson, MN (US); Eric M. Reichenberger, Park City, KS (US); Joseph Mark Biggerstaff, Wichita, KS (US); Anthony D. Ward, Hesston, KS (US); Leonardo H. Ungaretti, Newton, KS (US); Craig C. May, Park City, KS (US)

(73) Assignee: AGCO CORPORATION, Duluth, GA (US)

(21) Appl. No.: 13/832,850

(22) Filed: Mar. 15, 2013

(51) Int. Cl. A01F 12/00

(52) U.S. Cl. CPC A01F 12/00
USPC 460/59

(57) ABSTRACT

In one embodiment, a combine harvester comprising a chassis; and a grain storage bin coupled to the chassis, the bin comprising a single-walled, plastic storage container for the storage of crop material processed by the combine harvester.

### TECHNICAL FIELD

The present disclosure is generally related to agriculture technology, and, more particularly, grain storage bins for combine harvesters.

### BACKGROUND

Combine harvesters are provided with a processing system comprising a combine core and a cleaning system. The combine core comprises one or more rotors used to thresh and separate grain. Within the cleaning system, oscillating sieve assemblies in conjunction with air flow remove the chaff from the threshed grain, the latter falling through the chaffer and sieve assembly to an oscillating clean grain pan. The clean grain pan, in turn, directs the clean grain to a discharge auger that elevates the grain to an onboard grain storage bin. A second oscillating pan directs materials other than grain over the edge of the bottom sieve assembly to a different discharge outlet for recirculation back through the threshing, separating and cleaning assemblies of the processing system to extract the previously unthreshed grain.

The grain storage bin is generally a welded, bolted, or riveted steel structure coupled to the chassis of the combine harvester and comprises several parts for support and containment of grain.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a schematic diagram that illustrates in a front perspective view an example embodiment of a combine harvester.

FIG. 2 is a schematic diagram that illustrates in a front perspective, fragmentary view an example embodiment of a front portion of a combine harvester with an embodiment of a single-walled, plastic grain storage bin with a support basket.

FIG. 3 is a schematic diagram that illustrates in a bottom perspective, fragmentary view an example embodiment of a single-walled, plastic grain storage bin.

FIG. 4 is a schematic diagram that illustrates in a top perspective, fragmentary view an example embodiment of a single-walled, plastic grain storage bin.

FIG. 5A is a schematic diagram that illustrates in a top-front perspective view an example embodiment of plastic grain storage bin.

FIG. 5B is a schematic diagram that illustrates in side elevation, outline view the plastic storage bin of FIG. 5A.

### DESCRIPTION OF EXAMPLE EMBODIMENTS

### Overview

In one embodiment, a combine harvester comprising a chassis; and a grain storage bin coupled to the chassis, the bin comprising a single-walled, plastic storage container for the storage of crop material processed by the combine harvester.

### DETAILED DESCRIPTION

Certain embodiments of a combine harvester having a plastic grain storage bin are disclosed that may reduce the quantity of parts and/or weight associated with conventional grain storage bins. In one embodiment, a combine harvester is disclosed with a single-walled, plastic grain storage bin that in some embodiments comprises a support basket (e.g., support structure) that at least partially surrounds and supports the bin.

Digressing briefly, traditional grain storage bins of combine harvesters comprise a welded, bolted, or riveted steel structure comprising several parts for support and containment of grain. Such large assemblies have many parts, and take considerable time to assemble. In certain embodiments of combine harvesters, the grain storage bin is comprised of a single-walled plastic material (or blend, such as a blend of polyethylene and nylon), reducing the quantity of sheet-type parts used to contain the crop material (e.g., grain), and possibly reducing the overall weight of the combine harvester.

Having summarized certain features of combine harvesters with plastic grain storage bins of the present disclosure, reference will now be made in detail to the description of the disclosure as illustrated in the drawings. While the disclosure will be described in connection with these drawings, there is no intent to limit it to the embodiment or embodiments disclosed herein. For instance, in the description that follows, one focus is on a combine harvester having a transverse-rotor design, though it should be appreciated within the context of the present disclosure that combine harvesters of other designs, such as hybrid, conventional, axial, or dual axial, may be used and hence are contemplated to be within the scope of the present disclosure. Further, although the description identifies or describes specifics of one or more embodiments, such specifics are not necessarily part of every embodiment, nor are all various stated advantages necessarily associated with a single embodiment or all embodiments. On the contrary, the intent is to cover all alternatives, modifications and equivalents included within the spirit and scope of the disclosure as defined by the appended claims. Further, it should be appreciated in the context of the present disclosure that the claims are not necessarily limited to the particular embodiments set out in the description.

Note that references hereinafter made to certain directions, such as, for example, “front”, “rear”, “left” and “right”, are made as viewed from the rear of the combine harvester looking forwardly.

Referring now to FIG. 1, shown is an example embodiment of a combine harvester 10 with a plastic grain storage bin. It should be understood by one having ordinary skill in the art, in the context of the present disclosure, that the example combine harvester 10 shown in FIG. 1 is merely illustrative, and that other combine configurations may be implemented in some embodiments. The example combine harvester 10 is shown in FIG. 1 without a header, and from front to back, comprises a feeder house 12 and an operator cab 14, followed by a processing system 16 that includes a combine core (e.g., with threshing and separating functionality) and a cleaning system. In operation, the combine harvester 10 includes a harvesting header at the front of the machine that cuts crop materials and delivers the cut crop materials to the front end of the feeder house 12. Such crop materials are moved upwardly and rearwardly within and beyond the feeder house 12 by a conveyor 18 until reaching a thresher rotor 20 of the processing system 16. The thresher rotor 20 comprises a single, transverse rotor, such as that found in a Gleaner® Super Series Combine by AGCO, though some embodiments may have a dual rotor or axial or hybrid configuration. The thresher rotor 20 processes the crop materials in known manner and passes a portion of the crop material (e.g., heavier chaff, corn stalks, etc.) toward the rear of the combine harvester 10 and another portion (e.g., grain and possibly light chaff) to a cleaning system of the processing system 16 to undergo a cleaning process, as described below. In some embodiments, such as in axial flow designs, the conveyor 18 may convey the cut crop material to a beater before reaching a rotor or rotors.

In the processing system 16, the crop materials undergo threshing and separating operations. In other words, the crop materials are threshed and separated by the thresher rotor 20 operating in cooperation with certain elements of a rotor cage 22, for instance, well-known foraminous processing members in the form of threshing concave assemblies and separator grate assemblies, with the grain (and possibly light chaff) escaping through the concave assemblies and the grate assemblies and onto one or more distribution augers 24 located beneath the processing system 16. Bulkier stalk and leaf materials are generally retained by the concave assemblies and the grate assemblies and are disbursed out from the processing system 16 and ultimately out of the rear of the combine harvester 10. The distribution augers 24 uniformly spread the crop material that falls upon it, with the spread crop material conveyed to accelerator rolls 26. The accelerator rolls 26 speed the descent of the crop material toward a cleaning system 28. Also shown is a transverse, air blowing apparatus 30 (e.g., fan, or equivalently, a blower), which discharges pressurized air through one or more ducts, such as ducts 32 (e.g., which in one embodiment, includes an upper duct and lower duct, as explained below, though not limited to two ducts) to the cleaning system 28 to facilitate the cleaning of the heavier crop material directly beneath the accelerator rolls 26 while causing the chaff to be carried out of the rear of the combine harvester 10. The cleaning system 28 includes plural stacked sieves 34 (e.g., also referred to herein as an oscillating sieve assembly), through which the fan 30 provides an additional push or influence (through a lower duct 32, as explained below) of the chaff flow to the rear of the combine harvester 10.

The cleaned grain that drops to the bottom of the cleaning system 28 is delivered by an auger 36 that transports the grain to a well-known elevator mechanism (not shown, but located on the right hand side of the combine harvester 10), which conveys the grain to a single-walled, plastic grain bin 38 (shown with flaps 40 extending from the sides of the grain bin 38) located at the top of the combine harvester 10. Any remaining chaff and partially or unthreshed grain is recirculated through the processing system 16 via a tailings return auger 42. Also shown is a pivoting grain unloading spout 44 (depicted in FIG. 1 in the storage position) encompassing an auger 46 that cooperates with a cross auger (not shown, but disposed beneath or within a bottom portion of the grain bin 38) to unload the processed grain from the combine harvester 10 to another vehicle. As should be appreciated by one having ordinary skill in the art, the combine harvester 10 also comprises a chassis 48 to which the wheels, drivetrain, steering assemblies, bin 38, cab 14, and processing system 16, among other components, are coupled. As combine processing and its associated components are known to those having ordinary skill in the art, further discussion of the same is omitted here for brevity.

FIG. 2 is a schematic diagram of a front portion of the combine harvester 10 and an embodiment of the plastic grain storage bin 38. Certain features of the combine harvester 10 that are depicted in FIG. 1 are omitted here for brevity. The plastic grain storage bin 38 (hereinafter, also merely “bin”) is single-walled and polygonal in shape to facilitate the deposit and high capacity storage of grain processed by the processing system 16 (FIG. 1). In one embodiment, the bin 38 is formed through a well-known plastic forming/molding process, such as a rotational molded process. In some embodiments, the bin may be formed according to other mechanisms, such as injection or blow molding processes. The bin 38 may be formed according to a plurality of different geometric configurations and/or sizes, with one goal toward achieving a compatible fit to the now-replaced metal grain storage bin (or in some embodiments, occupying a smaller space). In one embodiment, the bin 38 is surrounded (e.g., at least partially) using a support basket 50 that provides support for the bin 38. The support basket 50 may comprise a basket or lattice-type structure as shown, or be configured according to other well-known mechanisms for providing support. The support basket 50 may be embodied as a steel structure that is secured (e.g., bolted, screwed, compression tightened, etc.) to the bin 38, and/or in some embodiments, secured to itself and the chassis 48 (FIG. 1) of the combine harvester 10 while fitting tightly around the bin 38 to constrain significant expansion of the bin 38 during loading. In some embodiments, additional and/or other materials may be used for the bin 38. In some embodiments, the bin 38 is secured to the chassis 48, or in some embodiments, the support basket 50 may be secured to the chassis 48 (e.g., directly, or through another structure). Also shown is an aperture 52, through which a cross auger (not shown) may extend from an interior of the bin 38 and couple to (e.g., via a U-joint, etc.) the auger 46 of the grain unloading spout 44 (FIG. 1), enabling the passage of grain. In some embodiments, the aperture 52 may be omitted.

Referring to FIG. 3, shown is a bottom portion of the bin 38 of FIG. 2, with the support basket 50 (FIG. 2) and integral formations (e.g., pertaining to locations for placement of the support basket 50) of the bin 38 and the cab 14 (FIG. 2), among other features, omitted to avoid obfuscating certain features. In one embodiment, the bin 38 comprises apertures 52 and 54 disposed on the side and bottom, respectively, of the bin 38. Disposed transversely in the interior space of the bin 38 and shown in phantom (e.g., dashed lines) is a cross auger 56, which is disposed above and adjacent to a slanted bin surface 58 and extends through the aperture 52 (also shown in phantom) on the left-hand side of the bin 38. As indicated above, the cross auger 56 couples with the auger 46 (FIG. 1) of the grain unloading spout 44 (FIG. 1). In some embodiments, the slanted bin surface 58 may be partially omitted in the lowest portion, and replaced with a bottom aperture to expose the interior space of the bin 38 (e.g., occupied by the processed grain) to the cross auger 56 positioned directly beneath such a bottom aperture. For instance, occupying the space now shown as the lower portion of the slanted bin surface 58 may be a metal trough that supports at least the lower portion of the bin 38, and which surrounds (at least partially) the cross auger 56. Such a metal trough may have an aperture on the left-hand side to replace the aperture 52, enabling the cross auger 56 to convey the processed crop material or grain (e.g., threshed and separated and cleaned) to the auger 46 of the grain unloading spout 44 for discharge to another vehicle. Although described using augers for grain conveyance, it should be appreciated that in some embodiments, the augers may be used in conjunction with other conveying mechanisms or apparatuses (e.g., endless belts, slats, etc.), or in some embodiments, other conveying mechanisms or apparatuses may be used in lieu of the augers. The aperture 54 provides a passageway for an elevator mechanism (not shown) to deposit the processed grain into the bin 38. In some embodiments, the aperture 54 may be omitted, and the elevator mechanism may deposit the processed grain over the top side of the bin 38. In some embodiments, the bin 38 may include other or fewer apertures in some embodiments.

Referring to FIG. 4, shown is another view (e.g., top perspective view) of the bin 38, further revealing certain features of the bin 38 (and omitting certain features previously shown in FIGS. 1-2 for brevity and clarity in understanding). In the embodiment depicted in FIG. 4, the bin 38 comprises opposing, upright single-walled sides 60A, 60B, front upright single-walled side 62 with an aperture 64 optionally disposed therein approximately centrally in the transverse direction (though not limited to a centralized location), and single-walled, slanted bin surface 58 having a fore-to-aft upward slant. As best seen in FIG. 4, in one embodiment, the processed grain that is deposited on the cross auger 56 is conveyed past the aperture 52, which is disposed on the side 60A of the bin 38 in one embodiment, to the auger 46 of the grain unloading spout 44.

Attention is now directed to the bin 38 shown in FIGS. 5A-5B, with formations 66A and 66B (e.g., recesses) formed from the plastic molding process to enable members of the support basket 50 to fit compatibly thereon. The formations 66A and 66B are merely illustrative, and in some embodiments, there may be fewer or greater quantities of formations of the same or different geometrical configuration. The top, open area may be trimmed off during the plastic molding process, with the trimmings used for other structures on or off the combine harvester 10 (FIG. 1). For instance, the top area may be trimmed in such a way to form flaps 40 (FIG. 1), which are similar in function to a cardboard box with flaps. In other words, the flaps 40 may be intrinsically coupled to the sides of the bin 38, much like the flaps of a cardboard box. In some embodiments, the structures from the molding process may be removed and hingeably coupled (e.g., using hardware) to the bin 38, and/or used as other structures of the combine harvester 10 (or other machines). These flaps 40 serve to increase the grain bin capacity. Also shown in the aperture 52 located toward the bottom of the bin 38, which accommodates the cross auger 56 (FIG. 4). Looking along cut-away A-A and shown in FIG. 5B, an outline of the polygonal shape of the bin 38 with formations 66A and 66B, the aperture 52, and the slanted bin surface 58 are shown.

As is clear from the example embodiments described above, certain embodiments of a combine harvester 10 (FIG. 1) with plastic grain storage bin 38 (FIG. 1) may enable a reduction in assembly costs and/or quantity of parts associated with conventional metal grain bins.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and protected by the following claims.

At least the following is claimed:

1. A combine harvester, comprising:
a chassis;
a processing system coupled to the chassis, the processing system comprising threshing, separating, and cleaning components; and
a grain storage bin coupled to the chassis, the bin comprising a single-walled, plastic storage container for the storage of crop material processed by the processing system.

2. The combine harvester of claim 1, further comprising a support basket that at least partially surrounds and supports the bin.

3. The combine harvester of claim 2, wherein the support basket is comprised of metal.

4. The combine harvester of claim 1, wherein the bin is produced by a rotational molding process.

5. The combine harvester of claim 4, further comprising one or more additional structures formed from the rotational molding process, the one or more additional structures coupled to the chassis.

6. The combine harvester of claim 5, wherein one of the additional structures comprises a flap hingeably coupled to a side of the bin, the flap extending a grain holding capacity of the bin.

7. The combine harvester of claim 6, wherein the flap is intrinsically coupled to the side based on the rotational molding process.

8. The combine harvester of claim 1, wherein the bin comprises one or more apertures.

9. The combine harvester of claim 8, further comprising a conveying apparatus, wherein a first of the apertures is disposed on a side of the bin and enables passage of the processed crop material by the conveying apparatus from an interior space of the bin to a second conveying apparatus of an unloading spout.

10. The combine harvester of claim 8, wherein a second of the apertures enables a flow of the processed crop material to an interior space of the bin.

11. A combine harvester, comprising:
a chassis; and
a grain storage bin coupled to the chassis, the bin comprising a single-walled, plastic storage container for the storage of crop material processed by the combine harvester.

12. The combine harvester of claim 11, further comprising a processing system coupled to the chassis, the processing system comprising a threshing and separating rotor and a cleaning system.

13. The combine harvester of claim 11, further comprising a support basket that at least partially surrounds and supports the bin.

14. The combine harvester of claim 11, wherein the bin is produced by a rotational molding process.

15. The combine harvester of claim 11, wherein the bin comprises a flap hingeably coupled to a side of the bin, the flap extending a grain holding capacity of the bin.

16. The combine harvester of claim 15, wherein the flap is formed during the formation of the bin.

17. The combine harvester of claim 11, further comprising a conveying apparatus at least partially surrounded by a metal trough, wherein a first of plural apertures is disposed on the bottom of the bin and comprises an uninterrupted passageway between an interior space of the bin and the conveying apparatus.

18. The combine harvester of claim 17, further comprising a second aperture that enables a flow of the processed crop material to the interior space.

19. A combine harvester, comprising:
a chassis; and
a grain storage bin coupled to the chassis and at least partially surrounded by a support basket, the bin comprising a rotationally molded, single-walled, plastic storage container for the storage of crop material processed a processing system of the combine harvester.

20. The combine harvester of claim 19, wherein the processing system comprises a threshing and separating rotor and a cleaning system.
